(19) United States
(12) Patent Application Publication
(10) Pub. No.: US 2019/0126842 A1
(43) Pub. Date: May 2, 2019

(54) MOTOR VEHICLE SEAT HAVING AN ARMREST ASSEMBLY

(71) Applicant: Ford Global Technologies, LLC, Dearborn, MI (US)

(72) Inventors: Daniel T. Jackson, Basildon (GB); Ken George Dell, Rainham (GB)

(73) Assignee: Ford Global Technologies, LLC, Dearborn, MI (US)

(21) Appl. No.: 16/156,149

(22) Filed: Oct. 10, 2018

(30) Foreign Application Priority Data
Oct. 31, 2017 (GB) 1717967.2

(51) Int. Cl. B60R 11/00; B60N 2/75; B60N 3/10

(52) U.S. Cl. CPC B60R 11/00; B60N 2/79; B60R 2011/0089; B60R 2011/0014; B60R 2011/0084; B60N 3/103

(57) ABSTRACT

A motor vehicle seat is disclosed having an armrest assembly including an armrest and a retractable utility support arm having a ball-shaped mount for use when extended away from the armrest to mount a small item of utility in a passenger compartment of a motor vehicle. The ball-shaped mount is stowable when not in use in a recess formed in the armrest so as not to cause an obstruction within the passenger compartment.

### FIELD OF THE INVENTION

The present invention generally relates to motor vehicle seating, and more particularly relates to a motor vehicle seat armrest assembly that provides a universal mount for a small item of utility.

### BACKGROUND OF THE INVENTION

There is an increasing need for flexible seating in modern motor vehicles. This need will only increase further with the introduction of autonomous vehicles where there generally is less or no need for any of the occupants to face towards the front of the vehicle while the vehicle is in motion.

There is an ongoing need to provide one or more supports or mounts in a motor vehicle for what is referred to herein as ‘small items of utility’. A small item of utility is an item of small size and weight that requires to be supported in the motor vehicle. Some examples of ‘small items of utility’ are mobile phones, computer tablets, cup holders, mobile satellite navigation devices and map holders.

It is generally known to provide mounts for such small items of utility that are attachable to a mounting surface in the motor vehicle such as a windscreen or dashboard via a sucker mount. However, it may be problematic that such holders are only of use if the seating is mounted in the vehicle in a position where it is close to a suitable mounting surface for the holder. There is therefore a need for a more adaptable type of holder that does not rely on proximity to such a mounting surface.

### SUMMARY OF THE INVENTION

According to a first aspect of the invention, a motor vehicle seat having an armrest assembly is provided. The assembly includes an armrest having first and second ends and a recess formed in the first end. The assembly also includes a retractable utility support arm supported by the armrest to project from the first end of the armrest when in an extended deployed state, the retractable utility support arm having a ball-shaped mount at a free end thereof to which in use a small item of utility can be attached when the utility support arm is in the extended deployed state wherein, the armrest is rotatable from a substantially horizontal in-use position to a substantially vertical stowed position and, when the utility support arm is in a retracted stowed state, the ball-shaped end of the utility support arm is stowed within the recess in the first end of the armrest.

The retractable utility support arm may be an extendable telescopic arm comprised of a number of engaged parts having one of the parts fastened to the armrest and having the ball-shaped mount mounted at a free end of another one of the parts. The one part of the telescopic arm may be fastened to a structural part of the armrest. The parts of the telescopic arm may be cylindrical tubes of differing diameter engaged with one another.

Alternatively, the retractable utility support arm may be a flexible arm having one end slidingly engaged with a support in the armrest and having the ball-shaped mount at an opposite end thereof.

The support in the armrest may be formed by a structural part of the armrest.

The flexible arm may be a flexible metal jointed shaft.

As yet a further alternative, the retractable utility support arm may be a rigid arm having one end slidingly engaged with a support in the armrest and having the ball-shaped mount at an opposite end thereof. The rigid arm may be a rigid curved arm.

The support in the armrest may be formed by a structural part of the armrest.

The seat may be rotatable about a substantially vertical axis.

The seat may be a captain's chair having a pair of armrest assemblies, one armrest assembly on each side of the seat.

According to a second aspect of the invention there is provided a vehicle seat having an armrest assembly. The assembly includes an armrest having a recess formed in an end, and a retractable utility support arm supported to project from the end in an extended deployed state and having a ball-shaped mount at a free end to attach an item in the deployed state, wherein the ball-shaped end of the utility support arm is stowed within the recess in a retracted stowed state.

According to a third aspect of the invention, there is provided a seat armrest assembly. The assembly includes an armrest having a recess, and a retractable utility support arm supported to project from the recess in an extended deployed state and having a ball-shaped mount at a free end to attach an item in the deployed state, wherein the ball-shaped end of the utility support arm is stowed within the recess in a retracted stowed state.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1a is a diagrammatic view of a motor vehicle seat having an armrest assembly showing a telescopic arm in a deployed state;

FIG. 1b is a cross-sectional view on an enlarged scale through a first end of an armrest forming part of the armrest assembly shown in FIG. 1a showing a ball-shaped mount stowed in a recess in the first end of the armrest;

FIG. 2a is diagrammatic view of a first end of an armrest in accordance with a second embodiment showing a bendable flexible arm in a deployed state;

FIG. 2b is a cross-sectional view through the armrest shown in FIG. 2a showing a stowage passage in a structural part of the armrest for stowing the bendable flexible arm shown in FIG. 2a;

FIG. 3a is a cross-sectional view through an armrest forming part of a third embodiment of an armrest assembly showing a curved stowage passage in a structural part of the armrest for stowing a rigid curved arm shown in FIG. 3b;

FIG. 3b is a side view of a rigid curved arm forming part of an armrest assembly;

FIG. 4a is a side view of a small item of utility in the form of a cup holder attached to the ball-shaped mount at the end of the telescopic arm shown in FIG. 1a showing a female mount sectioned along the line X-X on FIG. 2b; and

FIG. 4b is an end view of the female mount shown in FIG. 4a.

### DETAILED DESCRIPTION OF THE PREFERRED EMBODIMENTS

It will be appreciated that the figures are diagrammatic in nature and are not intended to represent production ready components.

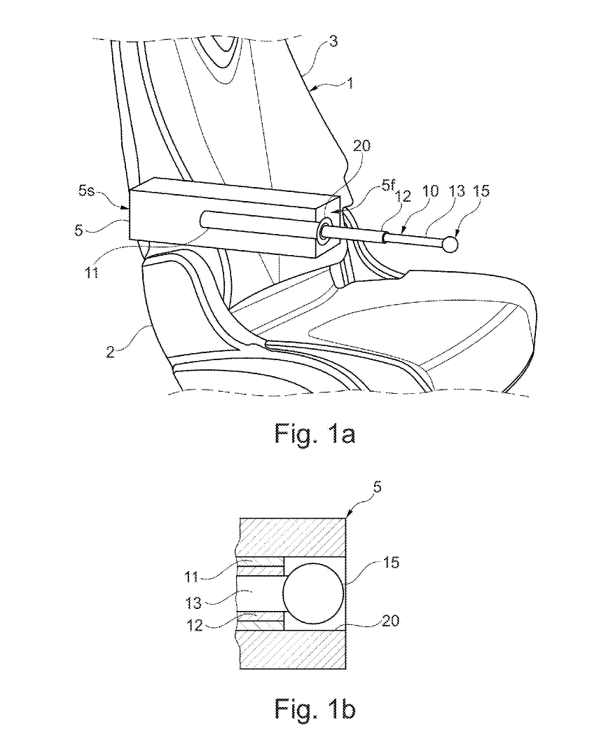

With particular reference to FIGS. 1a and 1b there is shown part of a motor vehicle seat 1 having a base 2 and a backrest 3. A first embodiment of an armrest assembly having an armrest 5 is shown pivotally attached to a right hand side of the backrest 3 of the motor vehicle seat 1.

The armrest 5 has a first end 5f and a second end 5s. The second end 5s of the armrest 5 is attached to the backrest 3 and the first end 5f is a free end that faces towards a front end of a motor vehicle (not shown) having a passenger compartment in which the vehicle seat 1 is mounted when the vehicle seat 1 is mounted in a forward facing position.

The armrest 5 is, in the case of this example, rotatable from a substantially horizontal in use position as shown in FIG. 1a to a substantially vertical stowed position (not shown).

It will be appreciated that the vehicle seat 1 can be mounted in the passenger compartment so as to be rotatable about a substantially vertical axis or can be mounted to permit only forward and rearward movement of the vehicle seat 1.

In an embodiment where the vehicle seat 1 is rotatably mounted, it can be in the form of a captain's chair having a pair of armrest assemblies one each side. In such an embodiment there would be one armrest 5 attached to a right hand side of the backrest 3 and one armrest 5 attached to a left hand side of the backrest 3.

The armrest assembly comprises the armrest 5 having a recess 20 formed in the first end 5f and a retractable utility support arm 10 supported by the armrest 5 so as to project from the first end 5f of the armrest 5 when in a deployed state.

The utility support arm 10 has a ball-shaped mount 15 at a free end thereof to which in use a small item of utility can be attached. When the utility support arm 10 is in a stowed state the ball-shaped mount 15 of the utility support arm 10 is stowed within the recess 20 in the first end 5f of the armrest 5.

The storage of the ball-shaped mount 15 in the storage recess 20 when the utility support arm 10 is not in use prevents damage from occurring to the utility support arm 10 and also prevents the utility support arm 10 from being an obstruction within the passenger compartment of the motor vehicle.

In this first embodiment, the utility support arm is in the form of a telescopic arm 10 comprising first, second and third cylindrical tubes 11, 12, and 13 of differing diameter engaged with one another having one end, namely the largest diameter first cylindrical tube 11, secured to a structural part of the armrest 5 and having the ball-shaped mount 15 mounted at an opposite end thereof on a free end of the smallest diameter third cylindrical tube 13. The first cylindrical tube 11 is fastened to the armrest 5 and forms a storage passage/guide for the other two tubes 12, 13.

To deploy the utility support arm 10, the ball-shaped mount 15 is grasped by a user and pulled out of the recess 20 in the armrest 5 causing the telescopic arm 10 to extend as the tubes 11, 12 and 13 disengage from one another.

To stow the utility support arm 10 from the deployed state, the ball-shaped mount 15 is grasped by a user and pushed towards the armrest 5 until it engages with the recess 20 in the armrest 5. This action causes the telescopic arm 10 to shorten in length as the first, second and third tubes 11, 12 and 13 slide into one another.

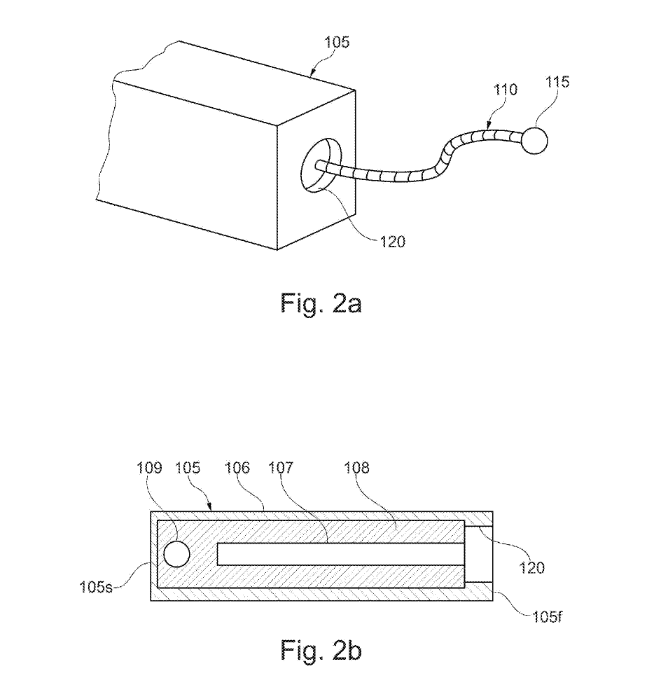

With reference to FIGS. 2a and 2b there is shown one embodiment of the armrest 105 with first and second ends 105f and 105s that is intended to be a direct replacement for the armrest 5 shown in FIG. 1a.

In this second embodiment, the retractable utility support arm is in the form of a flexible arm 110 having one end slidingly engaged with a passage 107 in a support forming part of the armrest 105. The support is formed by a structural part 108 of the armrest 108 sometimes referred to as an ‘armature’ located within a casing 106 in which is formed a recess 120 at the first end 105f of the armrest 105. The structural part 108 of the armrest 105 in the case of the example shown includes an aperture 109 used to pivotally connect the armrest 105 to a seat such as the seat 1 shown in FIG. 1a.

The flexible arm 110 has a ball-shaped mount 115 attached at an opposite end thereof to the end of the bendable arm 110 that is engaged with the passage 107.

In this example, the flexible arm 110 is in the form of a flexible metal jointed shaft such as the Gooseneck Flexible tubing manufactured by Whitehouse Flexible Tubing Ltd of Britten Street, Redditch, Worcestershire, UK. It will be appreciated that such Gooseneck Tubing can be provided with a decorative finish such as a plastic coating if required and that the invention is not limited to the use of such tubing other types of flexible arms could be used.

To deploy the utility support arm 110, the ball-shaped mount 115 is grasped by a user and pulled out of the recess 120 in the armrest 105 causing it to be pulled out from the passage 107. Although not shown in detail, an end stop is provided on the utility support arm 110 to prevent it from being fully disengaged from the passage 107. Once in the deployed state, the utility support arm 110 can be bent into a desired position by a user.

To stow the utility support arm 110 from the deployed state, the ball-shaped mount 115 is grasped by a user and pushed towards the armrest 105 until the ball-shaped mount 115 engages with the recess 120 in the armrest 105.

It will be appreciated that if the utility support arm 110 has been manipulated into a sinuous curved shape in the deployed state then it will need to be partially straightened in order to allow it to re-engage with the passage 107. However, it will be appreciated that the action of pushing the utility support arm 110 into the passage 107 will cause straightening of the utility support arm 110 to occur.

This embodiment has the advantage that the flexible nature of the utility support arm 110 permits the ball-shaped mount to be positioned in an optimal position for supporting a small item of utility.

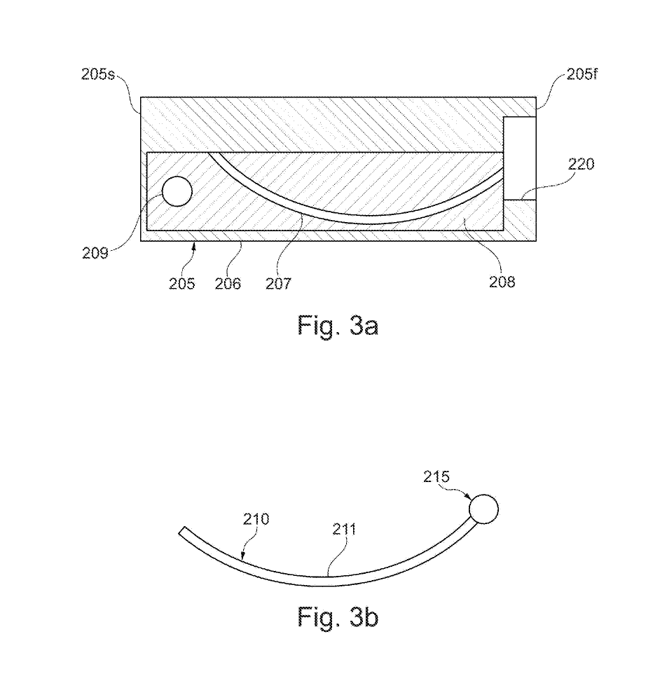

With reference to FIGS. 3a and 3b there is shown a third embodiment of an armrest 205 with first and second ends 205f and 205s that is intended to be a direct replacement for the armrest 5 shown in FIG. 1a.

In this third embodiment, the retractable utility support arm 210 is in the form of a rigid arm 211 having a ball-shaped mount 215 attached to one end. The rigid arm in the case of this example is in the form of a curved arm 211 but could be straight and has one end slidingly engaged with a passage 207 in a support forming part of the armrest 205. Although not shown in detail, an end stop is provided on the utility support arm 210 to prevent it from being fully disengaged from the passage 207.

The support is formed by a structural part 208 of the armrest 205 located within a casing 206 in which is formed a recess 220 at the first end 205f of the armrest 205. The structural part 208 of the armrest 205 in the case of the example shown includes an aperture 209 used to pivotally connect the armrest 205 to a seat such as the seat 1 shown in FIG. 1a.

The curved arm 211 has a ball-shaped mount 115 attached at an opposite end thereof to the end of the curved arm 211 that is engaged with the passage 207 in the armrest 205. The passage 207 is curved to match the shape of the curved arm 211 and although not shown could include bearings or guides to ease the process of engagement and dis-engagement of the curved arm 211 with the passage 207.

It will also be appreciated that other devices or structures could be used to support the curved arm 211 and that the invention is not limited to the use of a continuous passage, for example, a number of discrete supports could be used.

To deploy the utility support arm 210, the ball-shaped mount 215 is grasped by a user and pulled out of the recess 220 in the armrest 205 causing the curved arm 211 to be pulled out of the passage 207 thereby extending the utility support arm 210 and positioning the ball-shaped mount 215 away from the first end 205f of the armrest 205.

In this embodiment, the ball-shaped mount 215 will follow a simple arcuate path in an upward direction but it will be appreciated that if the passage 207 is formed in a component that is rotatably mounted in the structural part 208 of the armrest 205 then lateral and vertical displacement of the ball-shaped mount 215 is achievable.

To stow the utility support arm 210 from the deployed state, the ball-shaped mount 215 is grasped by a user and pushed towards the armrest 205 until it engages with the recess 220 in the armrest 205.

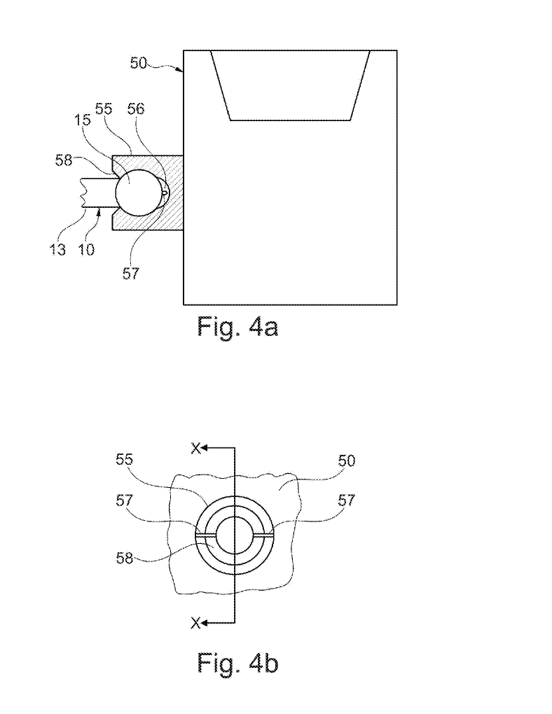

With particular reference to FIGS. 4a and 4b, there is shown a small item of utility in the form of a cup holder 50 attached to a ball-shaped mount which in this case is the ball-shaped mount 15 at the end of the tube 13 forming part of the telescopic arm 10 shown in FIG. 1a. It will however be appreciated that the cup holder 50 could alternatively be mounted on the ball-shaped mount 115 shown in FIG. 2a or on the ball-shaped mount shown in FIG. 3a.

The cup holder 50 includes a split female mount 55 having two parts divided by a pair of slots 57 and is made from a resilient plastic material that is shown in cross-section in FIG. 4a. A tapered lead-in 58 is provided to assist with engagement of the ball-shaped mount 15 with a part spherical cavity 56 formed in the female mount 55 used to accommodate the ball-shaped mount 15.

The ball-shaped mount 15 is an interference fit in the part spherical cavity 56 so that a clamping force is provided by the interaction of the ball-shaped mount 15 with the part spherical cavity 56 in the female mount 55.

It will be appreciated that other forms of female mount can be used and that the invention is not limited to use with the female mount 55 shown in FIGS. 4a and 4b.

Therefore in summary, a motor vehicle seat armrest is disclosed in which a deployable mount for supporting a small item of utility is included as part of the armrest. The mount is stowable in the armrest when not in use so as not to cause an obstruction with a passenger compartment of a motor vehicle. In various disclosed embodiments, at least one part of the retractable utility support arm is slidingly mounted on the armrest so that the ball-shaped mount can be slideable mounted for movement between its stowed and deployed positions.

One advantage of such an arrangement is that the deployable mount does not require the use of an additional surface to mount it and is positioned wherever the seat to which the armrest is connected is located within the passenger compartment of the motor vehicle.

The use of a ball-shaped mount provides a universal mount for a number of differing items of utility (small objects) and allows orientation of any item so mounted into a preferred orientation.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A motor vehicle seat having an armrest assembly the comprising:
an armrest having first and second ends and a recess formed in the first end; and
a retractable utility support arm supported by the armrest to project from the first end of the armrest when in an extended deployed state, the retractable utility support arm having a ball-shaped mount at a free end thereof to which in use a small item of utility can be attached when the utility support arm is in the extended deployed state wherein, the armrest is rotatable from a substantially horizontal in-use position to a substantially vertical stowed position and, when the utility support arm is in a retracted stowed state, the ball-shaped end of the utility support arm is stowed within the recess in the first end of the armrest.

2. The motor vehicle seat as claimed in claim 1, wherein the retractable utility support arm is an extendable telescopic arm comprised of a number of engaged parts having one of the parts fastened to the armrest and having the ball-shaped mount mounted at a free end of another one of the parts.

3. The motor vehicle seat as claimed in claim 2, wherein the one part of the telescopic arm is fastened to a structural part of the armrest.

4. The motor vehicle seat as claimed in claim 2, wherein the parts of the telescopic arm are cylindrical tubes of differing diameter engaged with one another.

5. The motor vehicle seat as claimed in claim 1, wherein the retractable utility support arm is a flexible arm having one end slidingly engaged with a support in the armrest and having the ball-shaped mount at an opposite end thereof.

6. The motor vehicle seat as claimed in claim 5, wherein the flexible arm is a flexible metal jointed shaft.

7. The motor vehicle seat as claimed in claim 1, wherein the retractable utility support arm is a rigid arm having one end slidingly engaged with a support in the armrest and having the ball-shaped mount at an opposite end thereof.

8. The motor vehicle seat as claimed in claim 7, wherein the rigid arm is a rigid curved arm.

9. The motor vehicle seat as claimed in claim 5, wherein the support in the armrest is formed by a structural part of the armrest.

10. A vehicle seat having an armrest assembly comprising:
an armrest having a recess formed in an end; and
a retractable utility support arm supported to project from the end in an extended deployed state and having a ball-shaped mount at a free end to attach an item in the deployed state, wherein the ball-shaped end of the utility support arm is stowed within the recess in a retracted stowed state.

11. The vehicle seat as claimed in claim 10, wherein the armrest is rotatable from a substantially horizontal in use position to a substantially vertical stowed position.

12. The vehicle seat as claimed in claim 10, wherein the retractable utility support arm is an extendable telescopic arm comprised of a number of engaged parts having one of the parts fastened to the armrest and having the ball-shaped mount mounted at a free end of another one of the parts.

13. The vehicle seat as claimed in claim 12, wherein the one part of the telescopic arm is fastened to a structural part of the armrest.

14. The vehicle seat as claimed in claim 12, wherein the parts of the telescopic arm are cylindrical tubes of differing diameter engaged with one another.

15. The vehicle seat as claimed in claim 10, wherein the retractable utility support arm is a flexible arm having one end slidingly engaged with a support in the armrest and having the ball-shaped mount at an opposite end thereof.

16. The vehicle seat as claimed in claim 15, wherein the flexible arm is a flexible metal jointed shaft.

17. The vehicle seat as claimed in claim 10, wherein the retractable utility support arm is a rigid arm having one end slidingly engaged with a support in the armrest and having the ball-shaped mount at an opposite end thereof.

18. The vehicle seat as claimed in claim 17, wherein the rigid arm is a rigid curved arm.

19. The vehicle seat as claimed in claim 15, wherein the support in the armrest is formed by a structural part of the armrest.

20. A seat armrest assembly comprising:
an armrest having a recess; and
a retractable utility support arm supported to project from the recess in an extended deployed state and having a ball-shaped mount at a free end to attach an item in the deployed state, wherein the ball-shaped end of the utility support arm is stowed within the recess in a retracted stowed state.
